(19) United States
(12) Patent Application Publication
(10) Pub. No.: US 2004/0143635 A1
(43) Pub. Date: Jul. 22, 2004

(54) Regulating receipt of electronic mail

(76) Inventor: Nick Galea, Iklin (MT)

Correspondence Address: WILDMAN, HARROLD, ALLEN & DIXON, 225 WEST WACKER DRIVE, CHICAGO, IL, 60606, US

(21) Appl. No.: 10/756,907

(22) Filed: Jan. 14, 2004

(30) Foreign Application Priority Data
Jan. 15, 2003 (GB) 0300912.3

(51) Int. Cl. G06F 15/16

(52) U.S. Cl. 709/206

(57) ABSTRACT

In filtering out the receipt by one or more users of mass mailings of unsolicited electronic mail, know as spam, a pass list or whitelist is built of electronic mail addresses to which the user or users send electronic mail. Incoming electronic mail from members of the pass list or whitelist bypasses the filter for unsolicited electronic mail, to avoid a possibility of electronic mail from such known correspondents being mistakenly identified as unsolicited electronic mail by the filter.

The present invention relates to a system and method for regulating the receipt of electronic mail.

It is known for advertisers and other bodies or individuals to send unsolicited identical or tailored electronic mail messages, often to a list of many electronic mail addresses. This unsolicited electronic mail is known colloquially as “spam”. Such unsolicited mass mailings of messages is relatively inexpensive to send but may represent not only a nuisance but also a significant cost to recipients, who, in addition to the cost in time, may pay for log on time while receiving, reading and deleting unwanted and unsolicited electronic mail.

Filtering systems are known for detecting such unsolicited electronic mail at a mail server and deleting or otherwise preventing the unsolicited mail reaching an intended recipient served by the mail server. Such filtering, may, for example be carried out by analysis of the contents of electronic mail messages received by the mail server. However, it is possible for such filters to mistake electronic mail from senders known to the intended recipients as unsolicited mail. It is therefore known to generate a pass or whitelist of known senders so that electronic mail from senders on the whitelist is not filtered out but is delivered to intended recipients served by the mail server, without first being checked to determine whether the message represents unsolicited mail. Similar filters may be provided on personal computers not connected to, for example, a corporate mail server.

However, at least on a mail server serving a large number of users, the generation and maintenance of such a pass or whitelist is typically an onerous task. Where a mail server serves a plurality of users it is known to interrogate electronic mail address lists maintained by each of the users for outgoing electronic mail and to generate a composite pass or whitelist from all the entries in each of the address lists. This ensures that electronic mail received from any addresses included in any of the address lists is never treated as unsolicited mail but is delivered to the intended recipients served by the mail server. However, it is known that users correspond with electronic mail addresses which are not included in their address lists, and do not necessarily keep their address lists updated, so that such a method of generating a whitelist will not include all electronic mail addresses with which users of a mail server correspond. Moreover, the address lists may be frequently changed by users so that all the address lists must frequently be interrogated to update the whitelist.

That is, as the electronic mail spam problem becomes larger, for example, by senders of spam messages seeking to disguise spam messages as non-spam messages, anti-spam software must be stricter in its anti-spam rules, which causes false positives. False positives are valid messages from valid electronic mail senders, for example business partners, which are mistakenly marked as spam and deleted. The possibility of false positives hampers the deployment of anti-spam software. Whitelists have therefore been created which allow users to specify known electronic mail senders, e.g. business partners, so that these electronic mail senders will always be able to send the user electronic mail without the mail first being checked for spam. However creating and maintaining this list of electronic mail senders may require a major administrative effort, because it requires the collection of all electronic mail addresses of all recipients and senders with whom employees, or other users connected to a mail server, correspond. In addition, these electronic mail addresses are frequently changing.

It is an object of the present invention at least to mitigate the aforesaid disadvantages of the prior art.

According to a first aspect of the invention there is provided a system for regulating receipt of electronic mail comprising: capturing means for capturing an outgoing electronic mail message, outgoing electronic mail analysing means for determining an electronic mail address of at least one intended recipient of the outgoing electronic mail message; and list updating means for updating a pass list of electronic mail addresses with the at least one intended recipient of the outgoing electronic mail message.

Preferably, the system further comprises: incoming mail capture means for capturing incoming electronic mail messages, incoming electronic mail analysing means for determining whether an electronic mail address of a sender of the incoming electronic mail message is a member of the pass list; processing means for processing the incoming mail dependent on whether the electronic address of the incoming mail message is a member of the pass list.

Conveniently, the list updating means includes dating means for dating members of the pass list with a date that a message was last sent to that member.

Advantageously, the system further comprises pass list purging means for purging the pass list of members to which a message has not been sent for a predetermined time.

Preferably, the processing means includes forwarding means for forwarding the incoming message to an intended recipient if the address of the sender is a member of the pass list and analysing means for determining a probability that the incoming message is an unsolicited message if the address of the sender is not a member of the pass list.

Conveniently, the system further includes deletion means for deleting an incoming message which the analysing means determines is probably an unsolicited message.

According to a second aspect of the invention, there is provided a method for regulating receipt of electronic mail comprising the steps of: capturing an outgoing electronic mail message, analysing the outgoing electronic mail message to determine an electronic mail address of at least one intended recipient of the outgoing electronic mail message; and updating a pass list of electronic mail addresses with the at least one intended recipient of the outgoing electronic mail message.

Preferably, the method comprises the further steps of: capturing an incoming electronic mail message, analysing the incoming electronic mail message to determine whether an electronic mail address of a sender of the incoming electronic mail message is a member of the pass list; and processing the incoming message dependent on whether the electronic address of the sender of the incoming message is a member of the pass list.

Conveniently, the step of updating a pass list includes updating the pass list with the latest date on which a message has been sent to an address, for subsequent purging of addresses to which messages have not been sent within a predetermined period of time.

Preferably, the step of processing the incoming message comprises sending the message to the intended recipient if the address of the sender is on the pass list and submitting the message to analysis to determine whether the incoming message is likely to be an unsolicited message if the address of the sender is not on the pass list.

Conveniently, the method includes the further step of deleting the incoming message if it is found probable that the message is an unsolicited message and passing the message to the intended recipient if it is found improbable that the message is an unsolicited message.

According to a third aspect of the invention, there is provided a computer program comprising code means for performing the steps of the method described above when the program is run on one or more computers.

The invention will now be described, by way of example, with reference to the accompanying drawings in which:

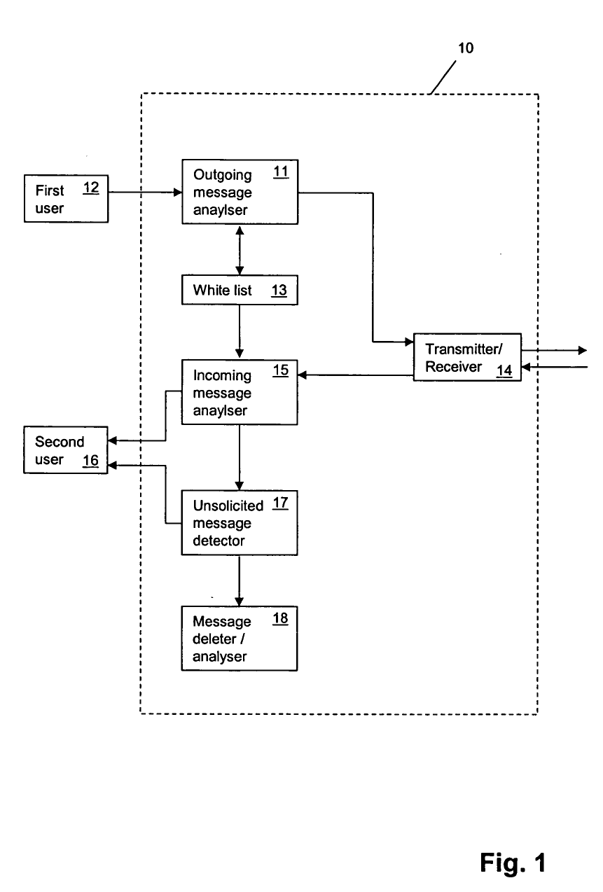

FIG. 1 is a block diagram of a system according to a first aspect of the present invention; and

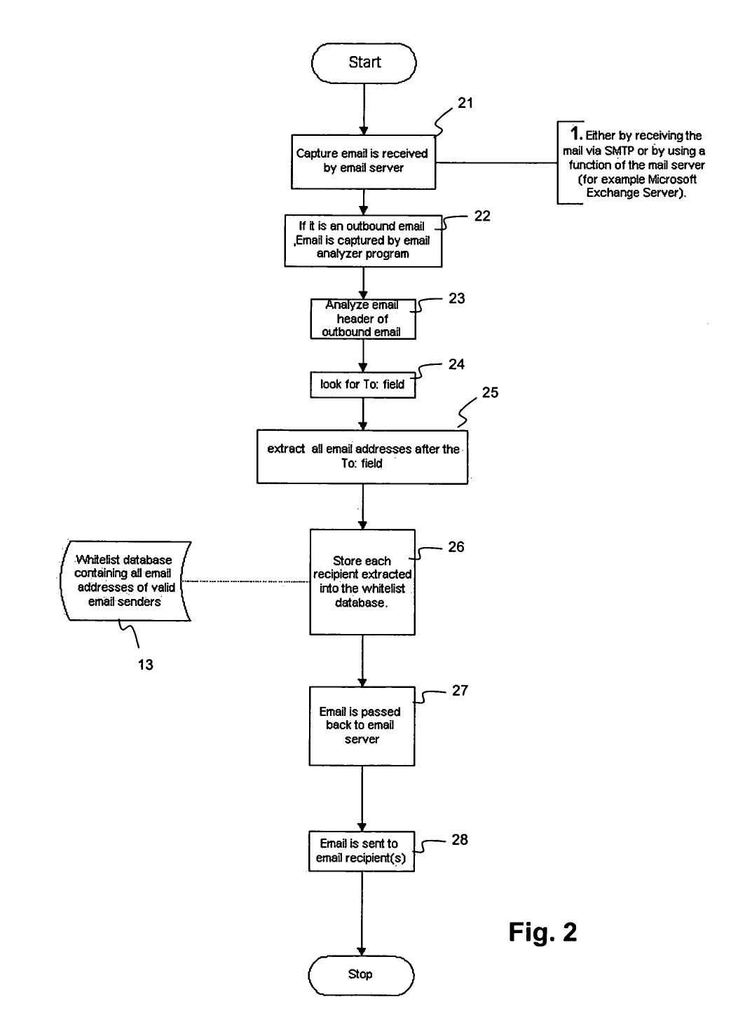

FIG. 2 is a flowchart of a method according to a second aspect of the invention.

Referring to FIG. 1, an electronic mail server 10 includes an outgoing message analyser 11 for receiving an outgoing electronic mail message from a first user 12 on a user network. The outgoing message analyser acts as an addressee extractor to extract details of addressees of the outgoing message to update a pass list or whitelist 13 with the addressees before passing the outgoing message to a transmitter/receiver 14 of the mail server for onward delivery.

The transmitter/receiver 14 of the mail server is further connected to an incoming message analyser 15 which acts as a sender analyser for analysing an incoming electronic mail message received by the transmitter/receiver 14 to extract sender details from the incoming message and determine whether the sender address is a member of the whitelist 13.

The sender analyser 15 is connected to the user network for forwarding a message directly to an intended recipient 16 where the sender is found to be a member of the whitelist and is connected to an unsolicited mail detector 17 for forwarding the message to the unsolicited mail or spam detector 17, where the sender is not a member of the whitelist, for analysing the message to determine whether the message is likely to be an unsolicited message, i.e. a spam message. The spam detector 17 is further connected to a message deleter 18 for deleting the message if it is determined that the message is likely to be an unsolicited mail message and connected to the user network for forwarding the message to the intended recipient 16 on the user network if the message is determined to be unlikely to be an unsolicited message. Rather than deleting a message suspected to be a spam message it will be understood that the suspect message may be stored or routed for subsequent evaluation or analysis.

Referring also to FIG. 2, the system of the invention therefore operates according to the following method. Electronic mail messages are received, step 21, by the electronic mail server 10 and outbound messages are captured, step 22, by the outgoing message analyser 11 which analyses, step 23, a header of the message to locate, step 24, an addressee field in the header. All electronic mail addresses in the addressee field are copied, step 25, from the addressee field and the whitelist 13 updated, step 26, with any addresses not already in the whitelist. The message is passed back, step 27 to the electronic mail server to be transmitted, step 28, to the intended recipients.

Incoming electronic mail messages are subsequently analysed, in a known manner, to determine whether a sender of the incoming message is included in the whitelist 13. If so, the incoming message is passed directly to the intended recipient 16, and only if the sender is not a member of the whitelist is the incoming message analysed to determine whether it is likely to be an unsolicited message. That is, if an address of a sender of an incoming message is on the whitelist, the incoming message will not be marked as an unsolicited message whatever the contents of the message.

It will be understood that the invention does not affect the possible checking of messages for, for example, viruses or offensive material, which checking may be carried out separately, irrespective of whether a sender is, or is not, included on the whitelist.

It will be further understood that rather than merely checking whether an addressee is already on the whitelist, the outgoing analyser may be used to update the whitelist with a latest date on which an electronic message has been sent to an addressee, so that the whitelist may periodically be purged of addresses which have not been used within a predetermined period of time, to avoid the whitelist growing larger than necessary by including redundant or no longer used addresses.

Provision may also be provided manually to update the whitelist, for example to remove addresses from which it is required to subject messages to anti-spam checking, even although an electronic mail message has been sent to that address. Similarly, provision may be provided to enquire of a user or administrator whether a new address should in fact be added to the whitelist before the whitelist is updated with the new address, so that, for example, if a user corresponds with a known source of spam messages, that address will not be added to the whitelist.

The invention therefore provides the advantage of automatically populating a whitelist of valid electronic mail senders, messages from whom will be excluded from anti-spam inbound mail-checking rules, by capturing electronic mail recipients of outbound electronic mail as they are sent. After installation of the system of the invention on a mail server, a mail analyser system intercepts all outbound mail and identifies the recipient of the mail. The recipient of the mail is then automatically added to the whitelist database if not already included. Using this system, anti-spam software will be required to analyse only mail from unknown senders, i.e. mail senders who have never been sent electronic mail by users of the mail server, resulting in a significant reduction of false positives as well as reduced processing time of inbound mail.

Although the invention has been described in relation to electronic mail services, it will be understood that the invention is applicable to any two-way communication system, for example voice or text messaging on wired or wireless telephone communication networks or interactive video services, where unsolicited messages or other communications may be sent to recipients. It will be understood that in the present context “unsolicited messages” includes identical or tailored messages sent to a multiplicity of recipients without their request and not, for example, a first individual message received from a new correspondent such as a potential client.

It is to be understood that modifications could be made and that all such modifications falling within the spirit and scope of the appended claims are intended to be included in the present invention.

1. A system of regulating receipt of electronic mail comprising:
a. capturing means for capturing an outgoing electronic mail message,
b. outgoing electronic mail analysing means for determining an electronic mail address of at least one intended recipient of the outgoing electronic mail message;
c. list updating means for updating a pass list of electronic mail addresses with the at least one intended recipient of the outgoing electronic mail message;
d. incoming mail capture means for capturing incoming electronic mail messages;
e. incoming electronic mail analysing means for determining whether an electronic mail address of a sender of the incoming electronic mail message is a member of the pass list and for forwarding the incoming message to an intended recipient if the address of the sender is a member of the pass list; and
f. analysing means for determining a probability that the incoming message is an unsolicited message if the address of the sender is not a member of the pass list and for forwarding the incoming message to the intended recipient if it is determined that the incoming message is probably not an unsolicited message.

2. A system as claimed in claim 1, wherein the list updating means includes dating means for dating members of the pass list with a date that a message was last sent to that member.

3. A system as claimed in claim 2, further comprising pass list purging means for purging the pass list of members to which a message has not been sent for a predetermined time.

4. A system as claimed in claim 1, further including deletion means for deleting an incoming message which the analysing means determines is probably an unsolicited message.

5. A method of regulating receipt of electronic mail comprising the steps of:
a. capturing an outgoing electronic mail message,
b. analysing the outgoing electronic mail message to determine an electronic mail address of at least one intended recipient of the outgoing electronic mail message;
c. updating a pass list of electronic mail addresses with the at least one intended recipient of the outgoing electronic mail message;
d. capturing an incoming electronic mail message,
e. analysing the incoming electronic mail message to determine whether an electronic mail address of a sender of the incoming electronic mail message is a member of the pass list;
f. passing the incoming electronic mail message to an addressee if the electronic address of the sender of the incoming message is a member of the pass list;
g. filtering the incoming message to analyse whether the incoming message is likely to be an unsolicited message if the address of the sender is not on the pass list; and
h. if the incoming message is found unlikely to be a unsolicited message forwarding the message to the addressee.

6. A method as claimed in claim 5, wherein the step of updating a pass list includes updating the pass list with the latest date on which a message has been sent to an address, for subsequent purging of addresses to which messages have not been sent within a predetermined period of time.

7. A method as claimed in claim 5, wherein the incoming message is deleted if it is found probable that the message is an unsolicited message.

8. A computer program comprising code means for performing all the steps of the method of any of claims 5 to 7 when the program is run on one or more computers.
